(19) United States
(12) Patent Application Publication
(10) Pub. No.: US 2008/0138786 A1
(43) Pub. Date: Jun. 12, 2008

(54) TRACKING LEARNING OBJECTIVES FOR ONLINE COURSES

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,363

(22) Filed: Sep. 6, 2007

Related U.S. Application Data
(60) Provisional application No. 60/824,750, filed on Sep. 6, 2006.

(51) Int. Cl. G09B 5/08

(52) U.S. Cl. 434/362

(57) ABSTRACT

A method and system track learning objectives in a computing environment for online courses. The method and system include creating course objectives that correlate with course materials for an online course. The course objectives include a value stored on an educational management system. A parameter is set for the course objectives and associating the parameter with the value. The parameter is stored on the educational management system. The course materials are distributed from the educational management system to a user's computer through a network connection. The outcome of a student's performance is tracked. The outcome includes a grade associated with the student. The outcome is compared to the course objectives to provide comparison data.

### CROSS-REFERENCE TO RELATED APPLICATIONS

This application claims the benefit of U.S. Provisional Patent Application No. 60/824,750, filed on Sep. 6, 2006, which is hereby incorporated by reference.

### BACKGROUND OF THE INVENTION

1. The Field of the Invention

The invention generally relates to online systems for educational course materials, and more particularly, to systems for tracking learning objectives for online courses.

2. The Relevant Technology

Web-based learning management system (LMS) and content management system (CMS) applications have transformed learning and education within corporations, government agencies and higher education institutions. Employees can take courses on their own time and at their own pace, while management and human resources are able to track progress. Students have access to more relevant content hosted by higher education faculties.

Online CMS systems have been implemented to enhance online and even hybrid courses. These courses give students key information they need outside the confines of the traditional university buildings. The distance learning students can gain access to the course materials by connecting to the Internet or other global network.

These systems present problems, for example, when employees are traveling and cannot connect to the corporate LMS or online courses. Likewise, deployed troops have limited connectivity to courses in the field. Many students are on a tight budget and have slow or no connectivity when off campus. And teachers who want to continue to do their work when they are at an offsite event are unable to work when away from their network.

### BRIEF SUMMARY OF THE INVENTION

A method tracks learning objects in a computing environment for online courses. The method includes creating course objectives that correlate with course materials for an online course. The course objectives include a value stored on an educational management system. The method sets a parameter for the course objectives and associates the parameter with the value. The parameter is stored on the educational management system. The course materials are distributed from the educational management system to a user's computer through a network connection. The outcome of a student's performance is tracked. The outcome includes a grade associated with the student. The outcome is compared to the course objectives to provide comparison data.

In another aspect of the invention, a system tracks learning objectives in a computing environment for online courses. The system includes a content provider having course materials for an online course to be accessed by a user's computer. The system includes an educational management system having a server and a database. The educational management system is configured to associate data with the course materials and correlate course objectives with the course materials. The course materials have a value. The educational management system includes parameters set for the course objectives, which are associated with the value. The system includes a network connection linked to the educational management system and configured to distribute the course materials from the content provider to the user's computer. The network connection provides a link to transfer information between the educational management system and the user's computer. The information transferred between the educational management system and the user's computer is associated with a particular online course and user in the database. The outcome of a student's performance is stored on the server and includes a grade associated with the student. The outcome is compared to the course objectives to provide comparison data, which is stored on the server.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-B are block diagrams illustrating an exemplary system capable of performing the invention;

FIG. 2 is a block diagram illustrating the method of the present invention;

FIGS. 3-4 are block diagram illustrating the method of the invention in a networked computing system;

FIG. 5 is a diagram illustrating the various services available via the distributed access protocol according to one aspect of the invention;

FIG. 6 is a diagram illustrating examples of the various integrating learning solutions that may be used in association with the invention;

FIG. 7 is an exemplary user interface illustrating the multimedia support;

FIG. 8 is an exemplary user interface illustrating a digital note taking application;

FIG. 9 is an exemplary user interface illustrating a search application; and

FIG. 10 is an exemplary user interface illustrating a personal planner application.

### DETAILED DESCRIPTION OF THE VARIOUS EMBODIMENTS

The principles of the various embodiments are described using the structure and operation of examples to illustrate the present invention. The embodiments provide the capability to track learning objectives for online courses, which are used, for example, in course materials, tests, assignments, quizzes, projects, and the like. The system measures the projected course objectives against the outcome.

Throughout the discussion of this system, the term “user” may be used to describe students, employees, content providers, educators, employers, or course administrators who are accessing the education management system using a computer. The computer may be any specific of general computer system that is equipped to receive, send, and process educational content. The computer may be, for example, a personal computer, or any other computing machine. A suitable computer system may include components such as a modem, monitor, keyboard, mouse, system software including support for TCP/IP communication, and other various types of software. While using the system, more than one user may connect to the education management system using the same computer.

The user's computer connects to the system by providing a user name and password. When the user connects to the system, the user's computer and the educational system perform a syncing operation. During the syncing operation, the educational system receives any work or new data that has been created or modified while the user's computer was offline and the user's computer receives any new information or data available on the educational system.

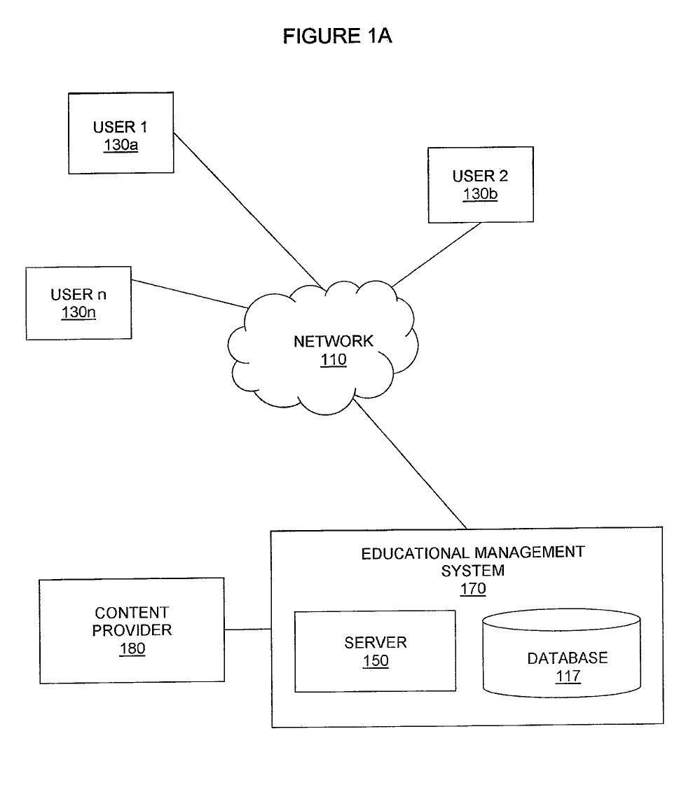

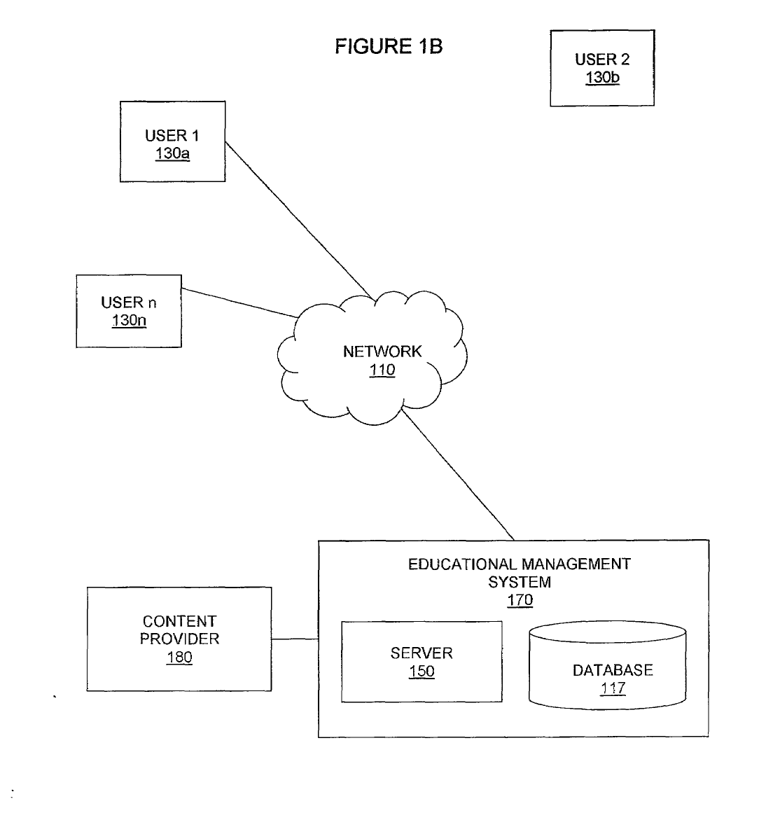

FIG. 1A is a block diagram illustrating an exemplary system capable of performing the present invention. As shown, the system includes a number of users, “User 1” 130a, “User 2” 130b, through “User n” 130n, who are connected to an educational management system 170 via a network connection 120. The network 120 may be any local or global network, including a LAN, wireless network, Internet connection, and the like.

In this embodiment, the education management system 170 includes a server 150 capable of sending and receiving communications and data via the network 120, and a database 160 capable of storing a plurality of educational software and data. In addition, the database 160 can be used to store data relating to the user identification and correlate the user's data to the user identification. As will be understood by one of ordinary skill in the art, any number of configurations may be used to create an education system, including systems using a series of interconnected databases, computers, and servers.

In this example, the education management system 170 is connected to a content provider 180. Here, the content provider 180 may be a third party content provider, who is responsible for creating various course software products to be used in the educational management system 170. Alternatively, the content provider 180 may be part of the education management system 170. Further, the content provider 180 may be an educator or course developer who connects to the education management system 170 as a user.

According to one embodiment of the present invention, the system may use a mechanism such as Bit Torrent or related protocol wherein the system may use a peer-to-peer communications protocol to share the educational content. Using such systems, the system typically breaks down any content into a number of smaller, identically-sized pieces, which are distributed among a plurality of users of the system who require the educational content. Then using a series of P2P connections, the files may be sent and received by the users over a period of time. Advantageously, this method of distribution is capable of distributing large amounts of data widely without requiring the content provider 180 or server 150 to incur the large costs of hardware, hosting, and bandwidth resources that would otherwise be required to distribute the educational content. Further, this embodiment would allow the “trickling” of downloads, meaning that in situations where the content to be downloaded is a large file, the system may permit the user to download smaller discrete portions of the content, instead of requiring a constant connection for the duration of the downloading process. The system can regulate the user downloads over a predetermined period. Thus, in situations where a large number of identical files need to be distributed to a number of users of the system, for instance, at the beginning of a semester or session when each student of the program requires the content associated with the course, the present invention may be effectively distributed without overwhelming the education management system 170.

FIG. 1B illustrates the ability of the present invention to be used when a user, here “User 2” 130b is no longer connected to the education management system 170. As described more fully below, one advantage of the present invention is the ability to transfer or distribute software onto “User 2's” 130b computer which enables “User 2” 130b to continue using the educational software when the computer is not connected to the management system 170. The system operates by distributing various learning software onto the user's computer when the user is connected to the system, to allow the user to use the learning software while not being connected to the system. Later, According to the invention, when “User 2” 130b later establishes a connection with the educational management system 170, such as the connection shown in FIG. 1A, the system 170 will perform a syncing operation, wherein it will send and receive data from the “User 2” computer 130b until both the system 170 and the “User 2” 130b have updated information.

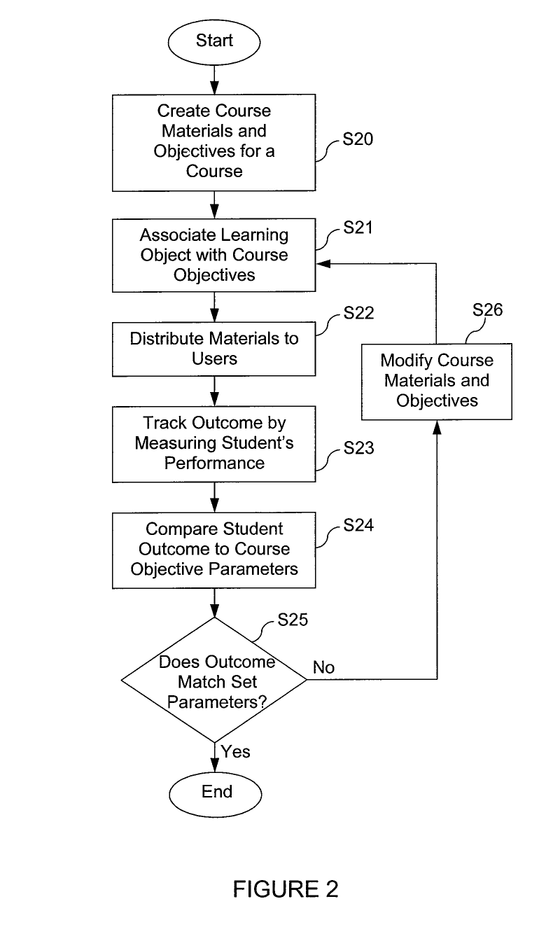

FIG. 2 is a block diagram illustrating a process for performing the present invention in a networked computer environment. At step S20, course materials and objectives are created for a particular course. The course materials and objectives are stored on the education management system. The course objectives are assigned descriptions such as “Mastery of 5 times tables,” “Understands the sequence of events leading to the Declaration of Independence,” “Relationship between velocity and acceleration,” and the like, to be compared to a student's performance. In step S21, each learning object in the course is associated with one or more of the course objectives. Assessments are also associated with learning objectives. Assessments may be entire assignments, quizzes or exams but more often they are individual questions within quizzes and exams. Parameters may be associated with these assignments. A parameter, for instance, can be selected based on student's expected performance on a course assignment, quiz, test, project, and the like. Parameters may have Boolean expressions, such as >, <, =, not, or any combination thereof, that are associated with the objectives to define a particular student expectation. For example, the students may be expected to achieve a grade >=80 percent of the total combined scores. The course materials in step S22 are distributed to users that are grouped with the particular course through a network connection. In step S23, the system tracks the course outcome by measuring the student(s)'s performance. The outcome can be measured, for example, in number of correct answers, letter grade, percentage, pass/fail expression or other methods typically used in the educational system and can be weighted to meet a specific course emphasis for the course. The system tallies the outcomes on each course objective for the students enrolled in the course that meet specified parameters. The outcome is tracked with a numeric value and the format is modified so that the values can be compared to the set parameters for the course.

In step S24, the student outcome is compared to the course objective parameters to provide comparison data. The comparison data can be stored in memory, such as on the server of the educational management system. If the outcome meets the set parameters in step S25, then the process ends. If not, the course materials and objectives are modified in step S26 and the process continues on from step S21, where the parameters are set again for the new course objectives. The outcome in this manner is tied back into the course objectives. If the parameters and objectives do not match, for example, if some students fail or obtain low scores, then the materials can be fixed or reevaluated. Mismatched values can be derived from the course materials or the student. If the course materials are flawed or otherwise inadequate, the teaching materials can be corrected to provide more effective learning tools, for instance, better examples, illustrations, and descriptions, the problems can be rewritten to clarify the questions or statements, and ambiguity can be reduced.

The outcome can be tracked at an element level, such as a problem in a quiz; an assignment level, such as the total grade for a quiz, test, assignment, or project; and/or a course level, such as the final grade for a particular course. At the element level, “bad” questions or problems can be isolated. If 90% of the students, for example, taking the exam miss a particular question, the question can be reevaluated to determine whether it has more than one answer, no correct answer, contains errors, or is ambiguous.

The outcome at an assignment level can be evaluated, for instance, to determine whether the students understood a certain topic for the course. The materials can be adjusted to compensate for any areas that were difficult for students to understand. An assignment, for example, can be modified to include more discussion about a certain topic, switched to a different type of project, or eliminated altogether.

At the course level, topics can be evaluated to determine whether all the objectives were met for the particular course. If it is determined, for example, that a particular course should cover ten topics but only nine topics were taught due to some unforeseen reason, such as time constraints, the course objectives or materials can be adjusted. If the teachers have a difficult time teaching all the course objectives within the allotted time, some assignments or projects may need to be shortened or eliminated. In this manner, the objectives are broken down by each course and measured against the outcome requirements. The values and comparison data can be displayed in numerical or graphical from to help a user identify potential problems with the course materials or objectives. Any problems can be fixed so that they are not repeated the next time the class is taught.

The system may also include a platform to distribute learning software. For example, the system can include Blackboard Backpack, Higher Ed Holdings Epic, Thompson Reader, or other software that can be coupled to the educational distribution system. The system enables users who are students to enroll in online courses to download course material, announcements, and bulletin board discussions. Course assignments can be completed with the student is offline. While the user is working offline, the system retains the learning functions. The user, for instance, is able to study course content and respond to bulletin board messages when working offline. When a connection is available and the user logs into the network, the user can upload his or her work and check for new course material. The system can accommodate multiple users from various learning environments that are leveraged by schools. The system can also track course delivery.

In scenarios where the user is an educator, course administrator, or content provider, the system enables the users to download course development material, coursework which has been previously submitted by students, discussions, lecture material, grade books, and the like. This enables educators, course developers, and course administrators to grade assignments, quizzes, tests, respond to message boards, and discussion threads while offline. Further, the system enables users to create or author content using an authoring software while offline. When a connection is later established, the user may log into the network and electively upload his or her work into the system.

Distributed learning enables the important components of an e-learning infrastructure to be distributed where and when needed, so that students, faculty, and workers that are not connected to the network can continue their learning and education anytime, anywhere. The users can review for an exam, continue a SCORM-based course, respond to a discussion thread, view a recording of a missed class or grade digitally turned-in assignments without the need for network access. Distributed learning extends the usefulness and scope of the present e-learning systems.

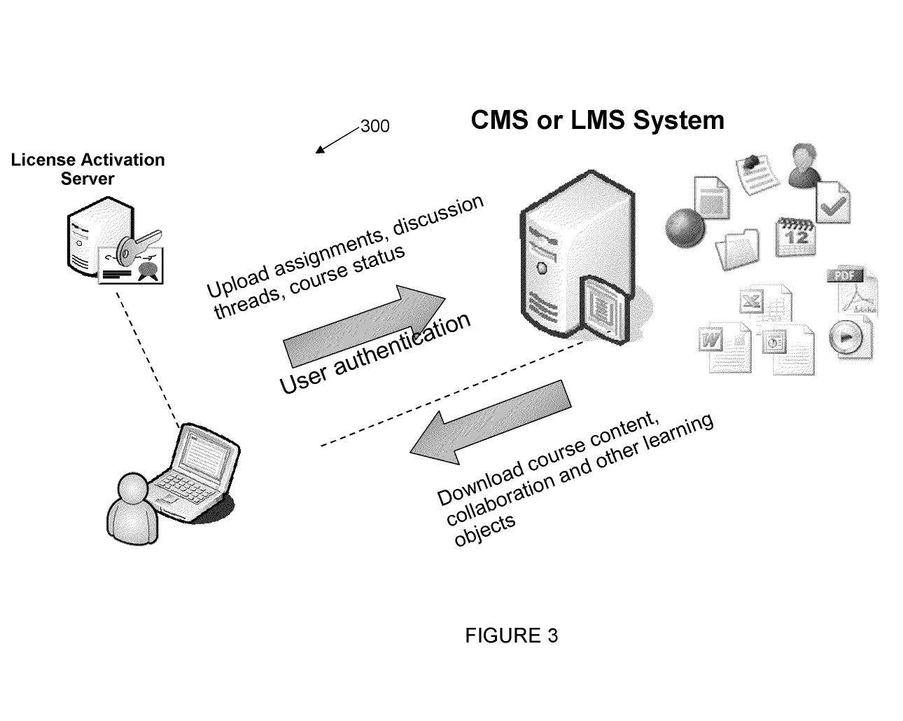

Distributed learning applications provide education institutions, corporations and government agencies with a number of benefits. As shown in FIG. 3, the user logs into the management system, such as CMS or LMS, to upload assignments, course status, or participate in discussion threads. And the user can download course content, collaboration with other users, or other learning objects. The user is not required to be connected to the management system to be able to work on the course materials. For example, the system enhances efficiencies of existing LMS or CMS system to users by expanding usage and minimizing downtime and leverages existing LMS or CMS infrastructure minimizing or eliminating need for changes. Also, it minimizes the need to have a 24/7 infrastructure to support LMS or CMS systems as users carry a copy with them. The system enables mobile workers, troops, faculty and students to be more efficient and effective by leveraging time that is often unproductive. And it allows users to personalize learning content through annotation, organization and digital additions, making their learning more effective.

The present invention includes a platform designed to enable rapid development of partner-branded distributed learning applications. In addition, the system takes learning to a new level by giving students, professionals, and teachers, additional tools to discover, capture, organize, annotate, and search learning content, making it easier to personalize the system to meet the user's individual needs.

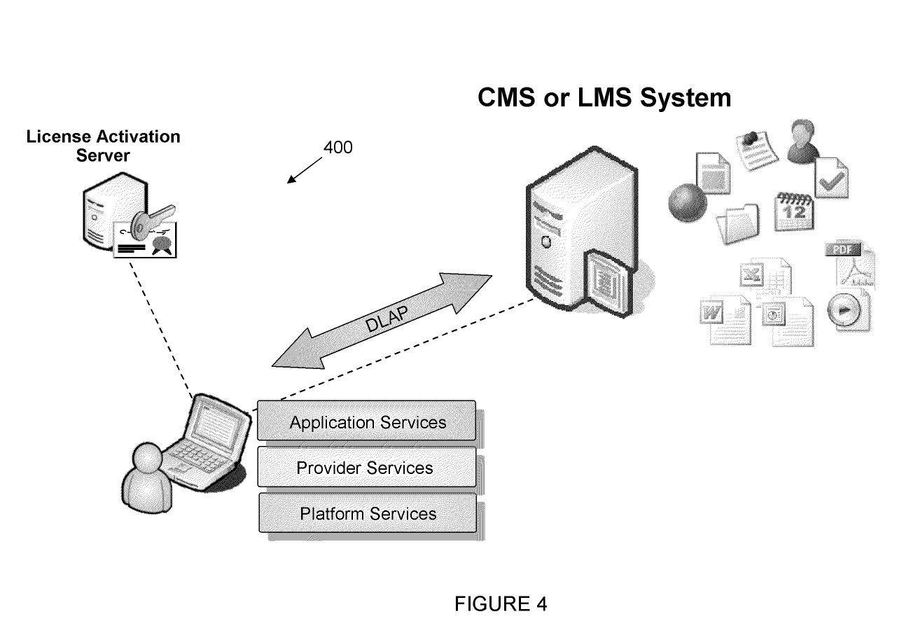

A powerful aspect of the distributed learning platform is the existing suite of components that enable rapid development. The architecture can be divided into four major layers: platform services, provider services, application services, and the distributed learning access protocol (DLAP) as illustrated in FIG. 4.

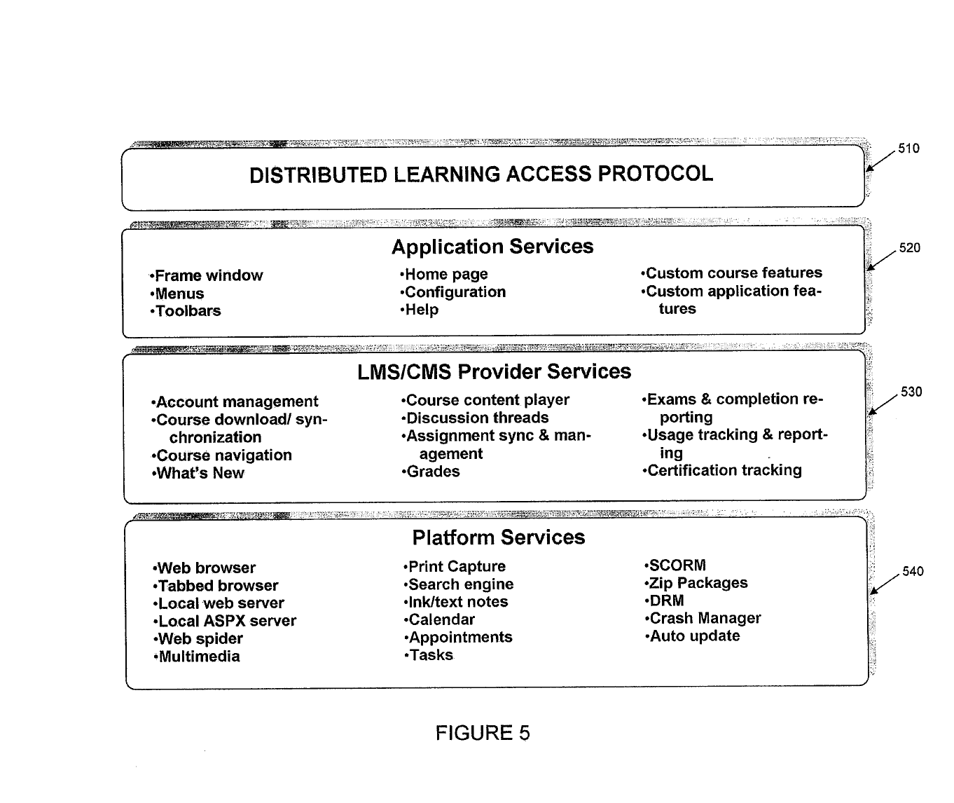

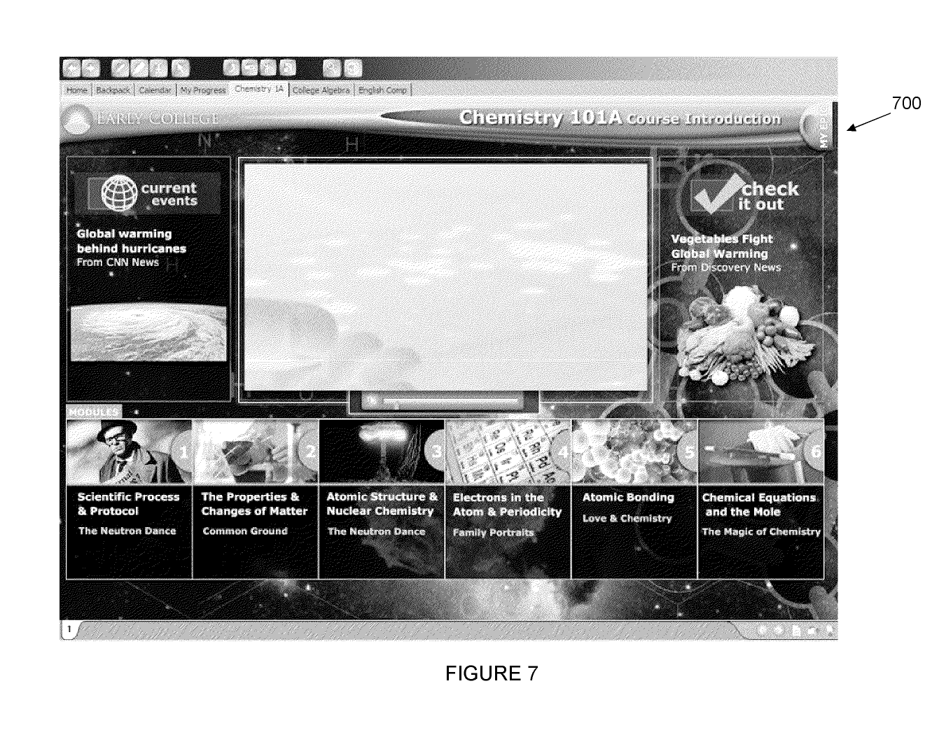

The platform services, as shown in FIGS. 4 and 5, are the core components upon which partner-branded applications are built. One well known component is a .NET ink and text note-taking control. In addition, these services include a web browser built on Internet Explorer controls that enable the application to play any content that works with Internet Explorer, including support for multimedia like Flash, QuickTime, Windows Media, and the like. A built-in offline SCORM content player is supported within the system, and is illustrated in FIG. 7. A print capture engine takes any Windows application print output and converts it to a digital note. Platform services support a robust search engine, built-in DRM, calendar, and local web, and ASPX servers. To support application management, the platform services also include an optional license activation manager to prevent unauthorized copying, a crash manager to help isolate problem areas and an auto-update service to keep user applications at the latest release level.

The system can also include security methods for preventing access to SCORM information by third parties. The security provides secure course materials for the users. With the security methods, the users can securely download, play, and store course materials, and securely transmit results, assignments, or answers. The added security is beneficial to government agencies with sensitive course materials. It also ensures that only authorized individuals consume course materials.

The ASPX server functionality can be emulated on a client device, like a local ASPX server. The system can include a client-side dynamic HTML rendering engine using “ASP .NET-like” technology. This aspect uses .NET compiler and execution modules to render dynamic, data-driven HTML. The local ASPX server is beneficial for developing rich, flexible HTML pages that display dynamic data. It also provides separate design of look-and-feel of a form from the data that gets displayed. The same model is used for dynamic web pages on a web server, although this engine works in a disconnected environment. In other words, all execution and dynamic logic occurs on the client machine.

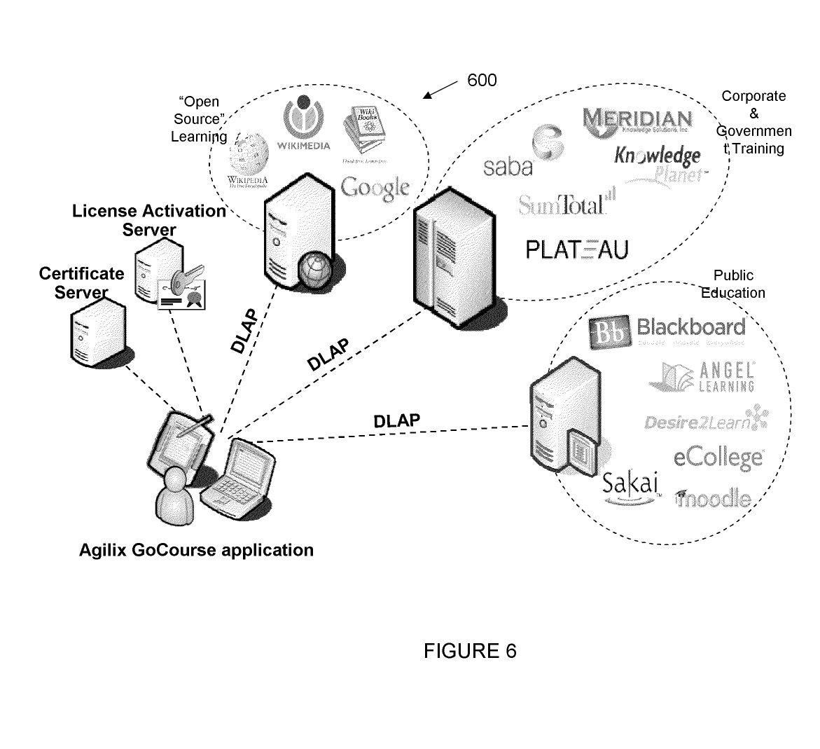

One aspect of the system is to download and upload objects from and/or to the CMS and LMS systems, also illustrated in FIGS. 4 and 6. To support that function, the system has built-in support for common CMS and LMS objects. The support serves can include course content, SCORM learning objects, collaboration, assignments, grades, assessments, and usage activity tracking. Objects can be downloaded or uploaded during any sync session. The application can be set up to support automatic or manual synchronization, with automatic synchronization done on a time-basis or by a specific event. The system also supports connection and user management to maintain links and user account authentication information. The user is authenticated when an identification number or other user identification, such as a user name and password or secure ID, is submitted to the provider and verified against a given account under the provider's license. Support for additional LMS and CMS objects also can be added to the system including a personal learning and research repository, PDF, MS Office, document annotation, digital note-taking, assignment planners, and search programs.

Part of any application branding effort is to create the right look and feel. Application services include the user interface components, such as windows, menus, toolbars, home pages, help, course support, and other custom features. The application services have support for 508 accessibility support. Also included is a configuration tool that makes it easy to create the user-defined options for the application. Custom components can be quickly built to meet unique needs of the partner-branded application.

In order for distributed learning applications to work, a set of APIs are available from the LMS or CMS system as a web service that can deliver high performance to the application built on the system. A web services-based protocol called Distributed Learning Access Protocol (DLAP) can be used between any distributed learning client and any LMS or CMS server. It is designed for very high performance, supports DRM-secure communications, and supports both learner and teacher activities. The system can include the DLAP and the related methods of permitting future third-party online eLearning systems to use defined application program interfaces that will facilitate interoperability and standardization.

A partner-branded application can include all of the key functionality to fit the target user. Some of the application modules are outlined below that can comprise the client. Other examples are illustrated in FIG. 6.

The system has the ability to send and receive content to and from the e-learning system. Supported content includes SCORM courses, course documents, discussion threads, and other asynchronous collaboration, assignments, grade book, usage status, and assessments. The system supports “round tripping” enabling content to be download or uploaded as necessary. Automatic or manual synchronization, whenever a network connection is available, is supported to keep content current and up-to-date. The course information can be bidirectional and sequential synchronized. This synchronization or “roundtripping” feature updates assignments and assessments. Students can download assignments and assessments to work on them in a environment that is disconnected from the network. The user can also upload results when a connection to the CMS/LMS is established. Furthermore, a user can also download instructor's comments and grades, and resubmit assignments.

The system can support a variety of offline teacher support programs, including a gradebook or spreadsheet-like application which allows an educator to manage all students and their grades for each gradable object. Using similar techniques, the system enables a teacher to download any completed work, including assignments, quizzes, or tests that have previously been completed and submitted to the system by users who are students.

The system can also support course development programs, such as an authoring client software product, which enables an author to create educational content. Such programs can enable learning unit authoring, exam editing, HTML editing, rich media support, document attachment, support for ZIP files, and grade book and assignment creators. The program may also provide the author the ability to review the course and the ability to later publish it to the educational management service, during a sync or similar operation.

In another embodiment of the invention, the system can also support a collaborative course authoring environment, where several educators and content providers can work together to develop course content. In one embodiment, the course content may be developed using a educator wiki-style program or similar environment where authorized users may download educational content and later create additional content, edit, remove, or change content, which may be uploaded to the educational server later in order to create course content in a collaborative manner. Advantageously, such a system would enable busy educators to easily and efficiently work together to create educational content.

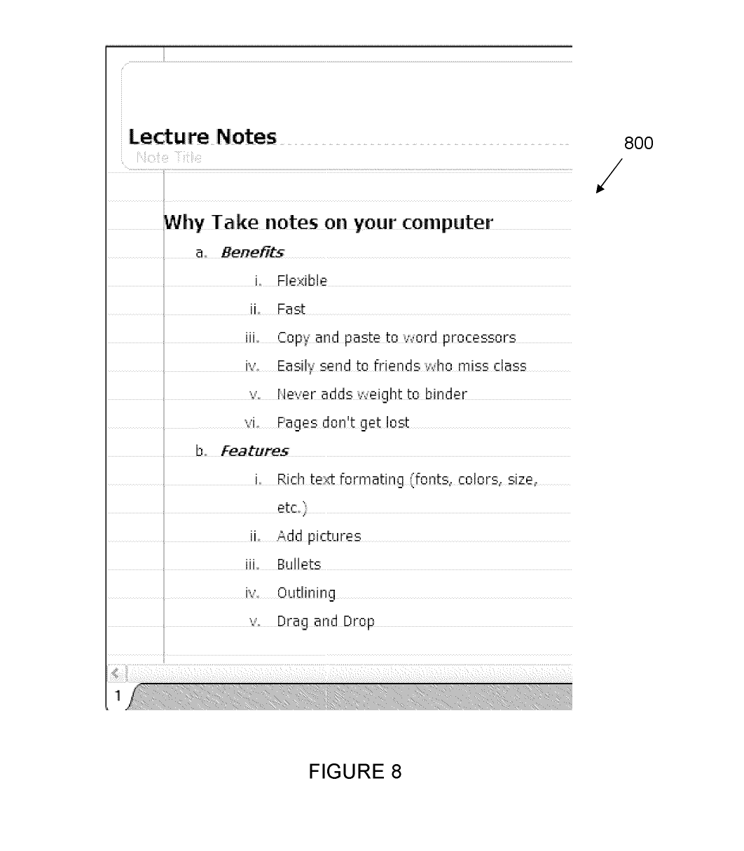

According to one aspect of the present invention, the system can support a digital note taking application, such as the sample illustrated in FIG. 8. The applications can include digital note-taking programs such as Agilix InfiNotes, which supports object-based note-taking with unlimited digital filler paper, rich text editing, and keyboard and ink support. It also allows users to add flags, hyperlinks to web pages and local documents and images to any notes. And all notes are fully searchable, including digital ink written words.

The system can capture a certified print driver that transforms printed output from any Windows XP application to an annotatable, InfiNotes-compatible note as illustrated in FIG. 8. Users can add their own notes, highlights and drawings to the digital note. And all text printed to the note is fully searchable.

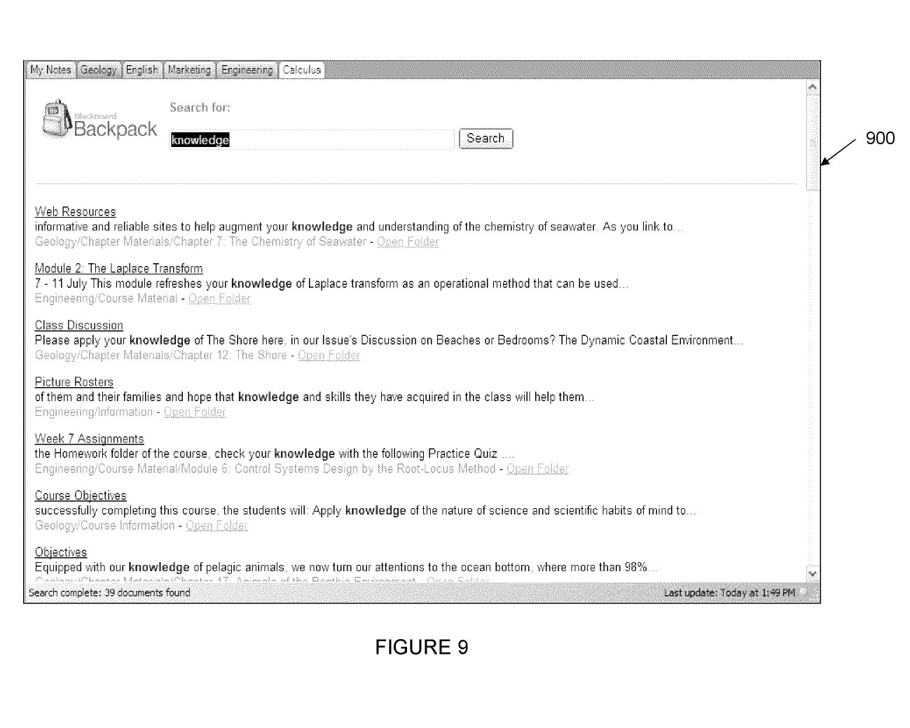

All downloaded content, handwritten notes and captured documents can be searched with a search engine. A personal research function can be added to enhance the system. The function can support full annotation such as highlighting, digital notes, hyperlinks, and pictures, such as those shown in FIG. 7. Output is displayed in order based on relevant search results, operating just like a browser. Users can filter the content by course or by personal notes or captured documents as shown in FIG. 9.

The browser can be a tabbed browser or a hybrid browser. The hybrid browser displays both web content and Windows Forms inside a unified browser with a common back and forward history. The browser is unified to display multiple tabs (targets), each with their own back and forward history and name. URL scheme can address a Windows Forms component, what data to display on the form, and in which target to display the form inside the unified browser. The hybrid browser includes many benefits such as being able to use “best of breed” tools or languages to display particular classes of data (i.e. Windows Form (function-rich) vs. HTML (media-rich)). The browser also includes seamless navigation, unified experience for user between HTML and form content. Container applications do not depend on how data is implemented or displayed as long as the applications know or use the correct URL syntax. Finally, the browser promotes easy reuse of Windows Forms and web page components by combining the URLs in new ways.

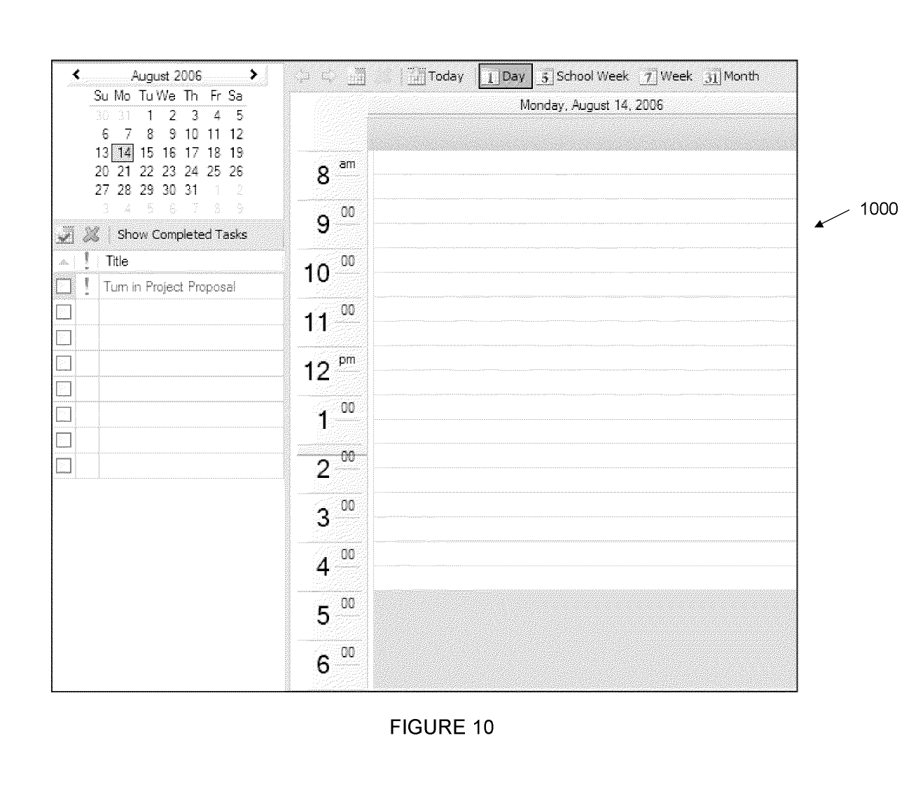

Based on the needs of the target audience, the application can include a calendar with four displays: daily, 5-day week, 7-day week and month, as depicted in FIG. 10. The calendar toolbar makes it easy to switch between views and add new appointments. In addition, the calendar can include a task manager to keep track of action items and assignments. Both the calendar and the task manager can be viewed based on a specific course or global information.

The applications may be developed with specific product specifications for a given application. The system can include server APIs to download and upload the learning objects. For example, the system can include DLAP, however, most SOAP/WSDL-based APIs will work, although some enhancements may be required to meet functionality and performance requirements. The system can also include access to test servers with sample content. In this way, the system can be developed and tested to make the solution meet specific user specifications.

The system supports all Windows XP computers running SP2. For example, it can be built on the .NET Framework 2.0. The system can also support Windows Vista as soon as it is publicly available.

End user documentation can be developed for the application. Tutorials and flash overviews can be provided to teach end users how to use the application. Training and first line support for the partner can be provided. And the license activation service can be integrated with the partner-branded application.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment for online courses, a method for tracking learning objectives, the method comprising:
creating course objectives that correlate with course materials for an online course, the course objectives including a description stored on an educational management system;
associating course objectives with learning objects and learning assessments;
distributing the course materials from the educational management system to a user's computer through a network connection;
tracking the outcome of a student's performance, the outcome including a grade associated with the student; and
comparing the outcome to the course objectives to provide comparison data.

2. The method of claim 1, wherein the step of creating course objectives includes assigning values to define a student's expectations.

3. The method of claim 2, wherein the step of associating objectives includes selecting a parameter based on student's expected performance on at least one of a course assignment, quiz, test, and project.

4. The method of claim 2, wherein the step of associating objectives includes defining a parameter associated with the objectives having a Boolean expression including at least one of >, <, =, and not.

5. The method of claim 1, wherein the step of distributing the course materials further comprises grouping the users according to a particular online course and distributing the materials to the users associated with the group.

6. The method of claim 1, wherein the step of tracking the outcome includes storing at least one of a number of correct answers, letter grade, percentage and pass/fail expression.

7. The method of claim 6, wherein the step of tracking the outcome includes an outcome that is weighted to meet a specific course emphasis for the online course.

8. The method of claim 1, wherein the step of tracking the outcome includes tallying the outcome for students enrolled in the online course.

9. The method of claim 1, wherein the step of tracking the outcome further comprises modifying the format of the values to provide a comparison to the parameter for the online course.

10. The method of claim 1, wherein the step of comparing the outcome further comprises storing the comparison data on the server of the educational management system.

11. The method of claim 1, further comprising modifying at least one of the course materials and the course objectives when the outcome and the parameter do not match.

12. The method of claim 1, wherein the step of tracking the outcome includes tracking at least one of the outcome at an element level, the outcome at an assignment level, and the outcome at a course level.

13. The method of claim 1, further comprising displaying the values in at least one of a numerical form and a graphical form.

14. The method of claim 1, further comprising displaying the comparison data in at least one of a numerical form and a graphical form.

15. A system for tracking learning objectives in a computing environment for online courses, the system comprising:
a content provider including course materials for an online course to be accessed by a user's computer;
an educational management system including a server and a database, the educational management system being configured to associate data with the course materials and correlate course objectives with the course materials, the course materials having a value, the educational management system including parameters set for the course objectives and associated with the value; and
a network connection linked to the educational management system and configured to distribute the course materials from the content provider to the user's computer, the network connection providing a link to transfer information between the educational management system and the user's computer,
wherein the information transferred between the educational management system and the user's computer is associated with a particular online course and user in the database, the outcome of a student's performance is stored on the server, the outcome includes a grade associated with the student, the outcome is compared to the course objectives to provide comparison data stored on the server.

16. The system of claim 15, wherein the educational management system assigns values related to the course objectives to define a student's expectations.

17. The system of claim 15, wherein the parameter is associated with the objectives having a Boolean expression including at least one of >, <, =, and not.

18. The system of claim 15, wherein the educational management system is configured to group the users according to a particular online course and distribute the materials to the users associated with the group.

19. The system of claim 15, wherein the educational management system is configured to modify the format of the values to provide a comparison to the parameter for the online course.

20. The system of claim 15, wherein the educational management system is configured to track at least one of the outcome at an element level, the outcome at an assignment level, and the outcome at a course level.

21. The system of claim 15, wherein the educational system is configured to transfer data to a user to display the values in at least one of a numerical form and a graphical form.

22. The system of claim 15, wherein the educational system is configured to transfer data to a user to display the comparison data in at least one of a numerical form and a graphical form.
